(19) United States
(12) Patent Application Publication
(10) Pub. No.: US 2017/0197592 A1
(43) Pub. Date: Jul. 13, 2017

(54) WINDSCREEN WIPER DEVICE

(71) Applicant: FEDERAL-MOGUL S.A., AUBANGE (BE)

(72) Inventor: THOMAS FRISCIONI, MEXY (FR)

(21) Appl. No.: 15/321,310

(22) PCT Filed: Jul. 16, 2014
(86) PCT No.: PCT/EP2014/065270

§ 371 Date: Dec. 22, 2016

(51) Int. Cl. B60S 1/40; B60S 1/38

(52) U.S. Cl. CPC B60S 1/4003; B60S 1/387; B60S 2001/3898

(57) ABSTRACT

A windscreen wiper device includes a connecting device (1) for an oscillating arm. The oscillating arm can he pivotally connected to the connecting device (1) about a pivot axis near a free end of the oscillating arm, with the interposition of a joint part (2), wherein the joint part (2) is detachably connected to the connecting device (1) by engaging protrusions (10, 11) of the connecting device (1), at the location of the pivot axis (10, 11), in recesses (12, 13) provided in the joint part (2). The connecting device (1) and the joint part (2) are arranged to enable its connection to an oscillating arm of at least three types.

### BACKGROUND

1. Technical Field

The present invention relates to a windscreen wiper device of the flat blade type comprising an elastic, elongated carrier element, as well as an elongated wiper blade of a flexible material, which can be placed in abutment with a windscreen to he wiped, which wiper blade includes at least one longitudinal groove, in which groove a longitudinal strip of the carrier element is disposed, which windscreen wiper device comprises a connecting device for an oscillating arm, wherein the oscillating arm can be pivotally connected to the connecting device about a pivot axis near a free end of the oscillating arm, with the interposition of a joint part, wherein the joint part is detachably connected to the connecting device by engaging protrusions of the connecting device, at the location of the pivot axis, in recesses provided in the joint part

2. Related Art

In use, the oscillating arm is connected to a mounting head mounted on a drive shaft, wherein the oscillating arm at one end thereof is pivotally connected to the mounting head by means of a pivot pin and at another end thereof is connected to the wiper blade placed in abutment with the windscreen to be wiped. In use, the shaft rotates alternately in a clockwise and in a counter-clockwise sense carrying the mounting head into rotation also, which in turn draws the oscillating arm into rotation and by means of the connecting device moves the wiper blade. The oscillating arm can thus oscillate to-and-from between a first reversal position and a second reversal position. The first reversal position may be identified as a position, wherein the arm members extend parallel to a windscreen to be wiped and are located near a lower edge of the windscreen to be wiped. Also, the second reversal position may be formulated as a position, wherein the arm members extend also parallel to a windscreen to be wiped and are located in a central region or near a side edge of the windscreen to be wiped.

The present invention also relates to a method for manufacturing such a windscreen wiper device.

It is noted that the present invention is not restricted to automobiles, but also refers to rail coaches and other (fast) vehicles.

Such a windscreen wiper device is generally known from European patent publication no. 1 403 156 of the same Applicant. This prior art windscreen wiper device is designed as a “yokeless” wiper device or “flat blade”, wherein no use is made of several yokes pivotally connected to each other, but wherein the wiper blade is biased by the carrier element, as a result of which it exhibits a specific curvature. In this prior art windscreen wiper device the joint part comprises at least one resilient tongue engaging in a correspondingly shaped hole provided in the oscillating arm, wherein the resilient tongue is rotatable along an hinge axis between an outward position retaining the wiper blade onto the oscillating arm and an inward position releasing the wiper blade from the oscillating arm. In order to connect the wiper blade onto the oscillating arm, the resilient tongue is initially pushed in against a spring force—as if it were a push button—and then allowed to spring back into the hole provided in the oscillating arm, thus snapping, that is clipping the resilient tongue into the hole. By subsequently pushing in again the resilient tongue against the spring force, the wiper blade may be released from the oscillating arm.

### SUMMARY OF THE INVENTION

The object of the invention is to provide an improved windscreen wiper device at minimum costs—without using complex machinery and additional tools—while the connecting device and the oscillating arm can be interconnected in a reliable and secure manner.

In order to accomplish that objective, a windscreen wiper device of the type referred to in the introduction is characterized according to the invention the protrusions of the connecting device are provided with coaxial through holes, wherein

an upper surface of the joint part comprises a recess arranged to accommodate a L-shaped shoulder provided near the free end of an oscillating arm of a first type, wherein the co-axial through holes are arranged to receive a transverse pivot pin provided near the free end of the oscillating arm of the first type, and wherein a side of the joint part is arranged to abut a leg of the L-shaped shoulder disposed at an end thereof and facing a windscreen to be wiped;

the joint part comprises at least one resilient tongue arranged to engage into a correspondingly shaped hole provided in a base of a U-shaped cross-section of an oscillating arm of a second type, wherein the resilient tongue is hingeable about a hinge axis between a inward position, wherein the wiper blade can be released from the oscillating arm of the second type, and an outward position, wherein the wiper blade can he retained on the oscillating arm of the second type;

the joint part is provided with a free end having a recess arranged to accommodate the free end of an oscillating arm of a third type, wherein the joint part comprises at least one protrusion extending laterally from a longitudinal side of the joint part, the protrusion being arranged to hook behind a correspondingly shaped protrusion on the oscillating arm of the third type for blocking a longitudinal movement of the wiper blade with respect to the oscillating arm of the third type.

Preferably, the connecting device is made in one piece of plastic and comprises an elongated flat base part, as well as a top part having a U-shaped cross-section, wherein a base and legs of the U-shaped cross-section define a channel between them arranged to accommodate a hook-shaped oscillating aim, as will be explained hereunder.

Preferably, the joint part is detachably connected to the connecting device particularly through a snapping/clipping operation, Further, the protrusions that function as bearing surfaces are spaced far apart, so that the forces exerted thereon will be relatively low. The protrusions extend outwards on either side of the connecting device, wherein the protrusions and their co-axial through holes are at least substantially cylindrical. Preferably, the protrusion on the joint part is resilient in order to snappingly connect the oscillating arm of the third type onto the joint part.

The joint part is arranged to be connected to the connecting device for different types of interconnection between the wiper blade and the oscillating arm, wherein the joint part is subsequently, connected to the connecting device by pivotally engaging protrusions of the connecting device, at the location of the pivot axis, in recesses provided in the joint part, and wherein the oscillating arm can be subsequently connected to the joint part. The essence of the present invention is that the connecting device and the joint part each are a universal connection for each type of interconnection between the wiper blade and the oscillating arm. A same type of the joint part to be connected to a same type of the connecting device may be used for each different type of interconnection between the wiper blade and the oscillating arm. The advantage achieved by the invention is that a unit consisting of the wiper blade, the connecting device and the joint part connected to the connecting device can he manufactured for each and every type of interconnection between the wiper blade and the oscillating arm. Thus, a universal connection between the wiper blade and the oscillating am is obtained, so that car drivers are given the possibility to buy also non-original cheap wiper blades fitting the original oscillating arms on their cars.

The present invention thus provides a universal connecting unit (consisting of the connecting device and the joint part) that is firmly attached to the oscillating arm of at least three types, i.e. a so-called “sidelock” connection, “bayonet” connection and “toplock” connection.

In a preferred embodiment of a windscreen wiper device in accordance with the invention the joint part has an at least substantially U-shaped cross-section at the location of its connection to the connection device, wherein the joint part in each leg of the U-shaped cross-section is provided with the recess provided co axially with the pivot axis, and wherein the co-axial recesses of the legs of the U-shaped cross-section and the co-axial through holes of the protrusions of the connecting device are arranged to receive the pivot pin of the oscillating arm of the first type. In other words, the diameter of the pivot pin is adapted to the diameter of the bearing holes or the co-axial through holes of the protrusions of the connecting device and to the diameter of the recesses provided in legs of the U-shaped cross-section of the joint part. Thus, the oscillating arm of the first type is provided with an extension comprising the pivot pin and the L-shape shoulder projecting out in the direction of the pivot pin and across the wiper blade and at the end of which is disposed the leg facing the windscreen to be wiped. Particularly, the joint part has a width of approximately 22 mm at the location of the L-shaped shoulder.

A side of the joint part facing away from the oscillating arm of the first type cooperates with a stop being formed by an inner wall of the leg, while securing of the wiper blade on the pivot pin toward the other side is taken over by the oscillating arm of the first type itself, as the pivot pin is fastened thereto.

In a further preferred embodiment of a windscreen wiper device according to the invention the joint part has an at least substantially U-shaped cross-section at the location of its connection to the connection device, wherein a base of the U-shaped cross-section of the joint part comprises the resilient tongue extending outwardly. Although the hinge axis could very well be located near an inner edge of the joint part, the hinge axis is preferably located near an outer edge of the joint part in order to avoid unintentional separation of the wiper blade from the oscillating arm of the second type.

In a further preferred embodiment of a windscreen wiper device in accordance with the invention wherein the joint part has an at least substantially U-shaped cross-section at the location of its connection to the connection device, wherein a base of the U-shaped cross-section of the joint part comprises the recess arranged to accommodate the free end of the oscillating arm of a third type. Particularly, the free end of the joint part is resilient and can pivot about a hinge axis between a first position for mounting or dismounting the free end of the oscillating arm of the third type into or from the recess in the base of the U-shaped cross-section of the joint part, and a second position for connecting the free end of the oscillating arm of the third type to the joint part. In the alternative (instead of the free end being resilient and pivotable) the protrusion(s) on the joint part is/are resilient. For connecting the oscillating arm of the third tape to the joint part the oscillating arm of the third type is pivoted relative to the joint part in an inclined position with respect to the wiper blade, so that the protrusion on the joint part is hooking behind the correspondingly shaped protrusion on the oscillating arm of the third type, wherein the oscillating arm is pivoted back relative to the joint part in a parallel position with respect to the wiper blade, so that a free end of the oscillating arm is snapped in the recess at the free end of the joint part.

In a further preferred embodiment of a windscreen wiper device according to the invention the connecting device comprises a longitudinal channel arranged to receive an oscillating arm of the fourth type comprising two longitudinal arm sections connected to each other by means of a curved intermediate section. Particularly, the joint part has an at least substantially U-shaped cross-section at the location of its connection to the connection device, wherein the longitudinal channel, a base and legs of the U-shaped cross-section of the joint part are arranged to receive a longitudinal arm section of the oscillating arm of the fourth type that in use is facing towards a windscreen to he wiped. In other words, the longitudinal arm section in use facing towards a windscreen to be wiped is introduced inside the channel and between the base and the legs of the U-shaped cross-section of the joint part. The channel preferably has a closed circumference.

In a further preferred embodiment of a windscreen wiper device in accordance with the invention the free end of the joint part is movable between an open position, wherein the wiper blade can be released from the oscillating arm of the fourth type, and an closed position, wherein the wiper blade can be retained on the oscillating arm of the fourth type. Particularly, the free end of the joint part is hingeable between the open and closed positions about a longitudinal axis of the windscreen wiper device. More in particular, the joint part comprises a cylindrical protrusion extending in longitudinal direction from one end thereof, while the free end thereof comprises a cylindrical recess extending in longitudinal direction as well for receiving the protrusion, such that the free end can be hingeably mounted onto the joint part.

In a further preferred embodiment of a windscreen wiper device according to the invention a cover is detachably connected to the joint part, preferably, by engaging protrusions of the connecting device, at the location of the pivot axis, in recesses provided in the cover. In particular, an upper surface of the cover comprises a recess arranged to accommodate

a rod-shaped oscillating arm of a fifth type;

a L-shaped shoulder near the free end of an oscillating arm of the first type.

Preferably, the cover is detachably connected to the joint part through a snapping clipping operation, the oscillating arm of the first type without a cover and with a cover used mutually differ in a distance between legs of the U-shaped cross-section of the oscillating arms, namely 19 mm and 22 mm, respectively.

In another preferred embodiment of a windscreen wiper device in accordance with the invention the cover comprises a cap provided with a protrusion in use extending in downward direction towards a windscreen to be wiped, and wherein the downwardly extending protrusion is adapted to engage in a correspondingly shaped hole provided in the oscillating arm of the fifth type for retaining the wiper blade onto the oscillating arm, the cap is preferably hingeably connected to the cover between a closed position, wherein the wiper blade is retained onto the oscillating arm of the fifth type, and an open position, wherein the wiper blade can be released from the oscillating arm of the fifth type.

In a further preferred embodiment of a windscreen wiper device according to the invention the cover has an at least substantially U-shaped cross-section at the location of its connection to the joint part, wherein the recess is provided in a base of the U-shaped cross-section.

In a further preferred embodiment of a windscreen wiper device in accordance with the invention the cover comprises two spaced-apart guiding protrusions extending upwardly from an upper surface of the cover, wherein the guiding protrusions are adapted to receive the oscillating arm of the fifth type between them.

As indicated, the present invention also relates to a method for manufacturing a windscreen wiper device of the flat blade type comprising an elastic, elongated carrier element, as well as an elongated wiper blade of a flexible material, which can be placed in abutment with a windscreen to he wiped, which wiper blade includes at least one longitudinal groove, in which groove a longitudinal strip of the carrier element is disposed, which windscreen wiper device comprises a connecting device for an oscillating arm, wherein the oscillating arm can be pivotally connected to the connecting device about a pivot axis near a free end of the oscillating arm, with the interposition of a joint part, wherein the joint part is detachably connected to the connecting device by engaging protrusions of the connecting device, at the location of the pivot axis, in recesses provided in the joint part, characterized in that the protrusions of the connecting device are provided with coaxial through holes, wherein

an upper surface of the joint part comprises a recess arranged to accommodate a L-shaped shoulder provided near the free end of an oscillating arm of a first type, wherein the co-axial through holes are arranged to receive a transverse pivot pin provided near the free end of the oscillating arm of the first type, and wherein a side of the joint part is arranged to abut a leg of the L-shaped shoulder disposed at an end thereof and facing a windscreen to be wiped;

the joint part comprises at least one resilient tongue arranged to engage into a correspondingly shaped hole provided in a base of a U-shaped cross-section of an oscillating arm of a second type, wherein the resilient tongue is hingeable about a hinge axis between a inward position, wherein the wiper blade can be released from the oscillating arm of the second type, and an outward position, wherein the wiper blade can be retained on the oscillating arm of the second type;

the joint part is provided with a free end having a recess arranged to accommodate the free end of an oscillating arm of a third type, wherein the joint part comprises at least one protrusion extending laterally from a longitudinal side of the joint part, the protrusion being arranged to hook behind a correspondingly shaped protrusion on the oscillating arm of the third type for blocking a longitudinal movement of the wiper blade with respect to the oscillating arm of the third type.

### THE DRAWINGS

The invention will now he explained more in detail with reference to figures illustrated in a drawing, wherein

FIGS. 1 and 2 are a schematic and perspective views of a connecting device, a joint part and a cover of a windscreen wiper device in a preferred embodiment of the invention in exploded position (FIG. 1) and in assembled position with and without the cover (FIG. 2);

FIG. 3 corresponds with FIG. 2, but shows a perspective view of several types of oscillating arms to be attached;

FIGS. 4 and 5 reveal several steps of mounting a unit consisting of the connecting device, the joint part and the cover of FIGS. 1, 2 and 3 to a hook-shaped oscillating arm;

FIG. 6 shows a perspective view, a side view and a top view of the connecting device of FIGS. 1, 2 and 3;

FIGS. 7 and 8 correspond to FIG. 6, but show an interconnecting of a hook-shaped oscillating arm and the connecting device of FIG. 6;

FIGS. 9 and 10 correspond to FIG. 6, but show an interconnecting of an oscillating arm of another type and the connecting device of FIG. 6 and the joint part of FIGS. 1, 2 and 3; and

FIGS. 11 and 12 correspond to FIG. 6, but show a perspective view of the connecting device and the joint part of FIGS. 1, 2 and 3 in exploded view and in assembled position (FIG. 12).

### DETAILED DESCRIPTION

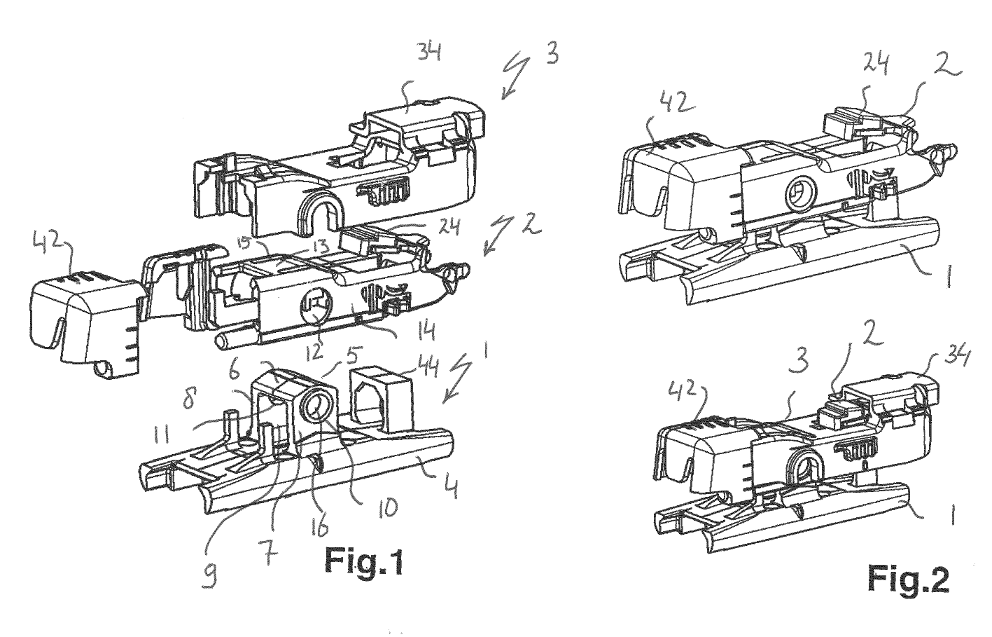

FIG. 1 shows a schematic and perspective view of a connecting device 1, a joint part 2 and a cover 3 in a preferred embodiment of the invention in exploded position to he used in a windscreen wiper device of the flat blade type. Such a windscreen wiper device of the flat blade type is typically built up of an elastomeric (rubber) wiper blade comprising a central longitudinal groove, wherein a longitudinal strip made of spring band steel is fitted in the longitudinal groove. The strip forms a flexible carrier element for the rubber wiper blade, as it were, which is thus biased in a curved position (the curvature in operative position being that of a windscreen to be wiped). Usually an end of the strip and/or an end of the wiper blade is connected on either side of the windscreen wiper device to respective connecting pieces or “end caps”. The connecting pieces may be formed as separate constructional elements, which may be form-locked as well as force-locked to both ends of the strip and/or ends of the wiper blade, In the alternative, the connecting pieces may he in one piece with the strip made of spring band steel. The windscreen wiper device is furthermore built up of a connecting device of metal for connecting an oscillating arm thereto, with the interposition of a joint part. The oscillating arm is pivotally connected to the connecting device about a pivot axis near one end.

In the present case the connecting device 1 is particularly welded, soldered, glued or clamped onto two spaced-apart longitudinal strips disposed on opposite sides in longitudinal grooves of the wiper blade. In the alternative or in addition thereto, the connecting device 1 is connected to the elastomeric (rubber) material of the wiper blade, for example glued or clamped.

Although not shown in the figures, but fully understood by a skilled person, the oscillating arm is connected to a mounting head fixed for rotation to a shaft driven by a small motor. In use, the shaft rotates alternately in a clockwise and in a counter-clockwise sense carrying the mounting head into rotation also, which in turn draws the oscillating arm into rotation and by means of the connecting device moves the wiper blade.

In FIG. 1 the connecting device 1 is made in one piece of plastic and comprises an elongated flat base part 4, as well as a top part 5 having a U-shaped cross-section, wherein a base 6 and legs 7,8 of the U-shaped cross-section define a channel 9 between them arranged to accommodate a hook-shaped oscillating arm, as will be explained hereunder. The legs 7,8 comprise cylindrical protrusions 10,11 extending laterally outwardly for snappingly and pivotally engaging into identically shaped recesses 12,13 in legs 14,15 of a U-shaped cross-section of the joint part 2. The protrusions 10,11 of the connecting device 1 and the recesses 12,13 of the joint part 2 are co-axial with the pivot axis. As shown, the protrusions 12,13 are equipped with through holes 16 also co-axial with the pivot axis. The protrusions 10,11 function as bearing surfaces at the location of the pivot axis in order to pivot the joint part 2 (and the oscillating arm attached thereto) about the pivot axis near one end of the oscillating arm. The protrusions 10,11 are preferably in one piece with the connecting device 1. In the alternative the protrusions 10,11 are part of a separate hollow pin to be inserted into opposite holes in the legs 7,8 of the connecting device 1 (not shown).

FIG. 2 is a perspective view of the connecting device 1 and the joint part 2 in assembled position (top of FIG. 2), whereas at the bottom of FIG. 2 a perspective view of the connecting device 1, the joint part 2, as well as the cover 3 in assembled position is shown. As depicted, in the latter position the cover 3 almost entirely surrounds the joint part 2.

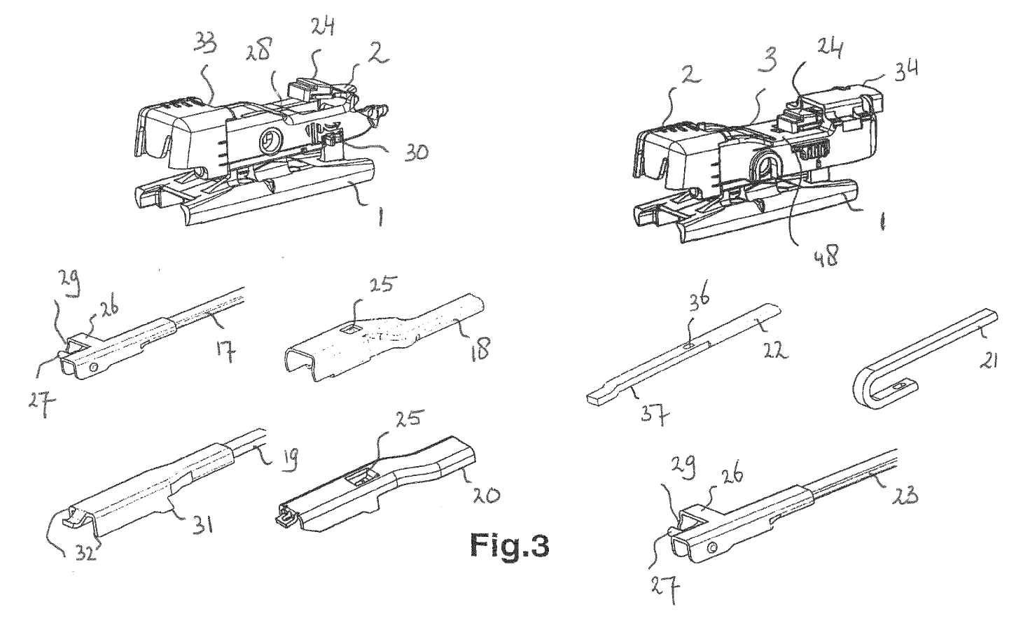

With reference to FIG. 3 on the left side, a unit consisting of the connecting device 1 and the joint part 2 is arranged to he connected to different types of oscillating arms, namely an oscillating arm 17 of a first type, an oscillating arm 18 of a second type, an oscillating arm 19 of a third type, as well as an oscillating arm 20 of another type being a combination of the second and third type oscillating arms 18,19. Again referring to FIG. 3 but now on the right side, a unit consisting of the connecting device 1, the joint part 2 and the cover 3 is arranged to be connected to other different types of oscillating arms, namely an oscillating arm 21 of a fourth type, an oscillating arm 22 of a fifth type, as well as an oscillating arm 23 of another type. The oscillating arms 17,23 mutually differ in a distance between legs of an U-shaped cross-section of the oscillating arms 17,23. The distance in the oscillating arm 17 of the first type is 19 mm, while the distance in the oscillating arm 23 of the other type is 22 mm.

As can be seen in FIG. 3, the joint part 2 comprises a resilient tongue 24 extending outwardly, while the oscillating arm 18,20 each have a U-shaped cross-section at the location of their connection to the joint part 2, so that the tongue 24 engages in an identically shaped hole 25 provided in a base of the U-shaped cross-section. The connecting device 1 with the wiper blade is mounted onto the oscillating arm 18,23 as follows. The joint part 2 being already clipped onto the connecting device 1 is pivoted relative to the connecting device 1, so that the joint part 2 can be easily slid on a free end of the oscillating arm 18,20. During this sliding movement the resilient tongue 24 is initially pushed in against a spring force and then allowed to spring back into the hole 25, thus snapping, that is clipping the resilient tongue 24 into the hole 25. This is a so-called bayonet connection. The oscillating arm 18,20 together with the joint part 2 may then he pivoted back in a position parallel to the wiper blade in order to be ready for use. By subsequently pushing in again the resilient tongue 24 against the spring force (as if it were a push button), the connecting device 1 and the joint part 2 together with the wiper blade may be released from the oscillating arm 18,20. Dismounting the connecting device 1 with the wiper blade from the oscillating arm 18,20 is thus realized by sliding the connecting device 1 and the joint part 2 together with the wiper blade in a direction away from the oscillating arm 18,20.

Again with reference to FIG. 3 on the left, the oscillating arm 17 of the first type is provided with an extension comprising a L-shape shoulder 26 and a transverse pivot pin 27, wherein the shoulder 26 projects out in the direction of the pivot pin 27 and across the wiper blade and at the end of which is disposed a leg 29 facing the windscreen to be wiped. An upper surface of the joint part 2 comprises a recess 28 arranged to accommodate the L-shaped shoulder 26, wherein the co-axial through holes 10 are arranged to receive the transverse pivot pin 27. In assembled position a side of the joint part 2 facing away from the oscillating arm 17 of the first type cooperates with a stop being formed by an inner wall of a leg 29 of the U-shaped shoulder 26, while securing of the wiper blade on the pivot pin 27 toward the other side is taken over by the oscillating arm 17 of the first type itself.

For connecting the oscillating arm 19 of the third type to the joint part 2 the oscillating arm 19 is pivoted relative to the joint part 2 in an inclined position with respect to the wiper blade, so that resilient protrusions 30 extending laterally outwardly on either side of the joint part 2 are hooking behind correspondingly shaped protrusions 31 on legs 32 of a U-shaped cross-section of the oscillating arm 19, the oscillating arm 19 is pivoted back relative to the joint part 2 in a parallel position with respect to the wiper blade, so that a free end of the oscillating arm 2 is snapped in a recess 33 at the free end of the joint part 2. Connecting the arm 20 of another type is carried out accordingly, with the difference that in addition the resilient tongue 24 of the joint part 2 is clipped inside the hole 25 of the oscillating arm 20.

As can be seen in FIG. 3 on the right, the cover 3 is snapped or clipped onto the protrusions 10,11 of the connecting device 1 on top of the joint part 2. The cover 3 comprises on its upper surface a recess 48 arranged to accommodate an L-shaped shoulder 26 of the oscillating arm 23, wherein the co-axial through holes 10 are arranged to receive an transverse pivot pin 27 of the oscillating arm 23. In assembled position a side of the cover 3 facing away from the oscillating arm 23 cooperates with a stop being formed by an inner wall of a leg 29 of the L-shaped shoulder 26, while securing of the wiper blade on the pivot pin 27 toward the other side is taken over by the oscillating arm 23 itself.

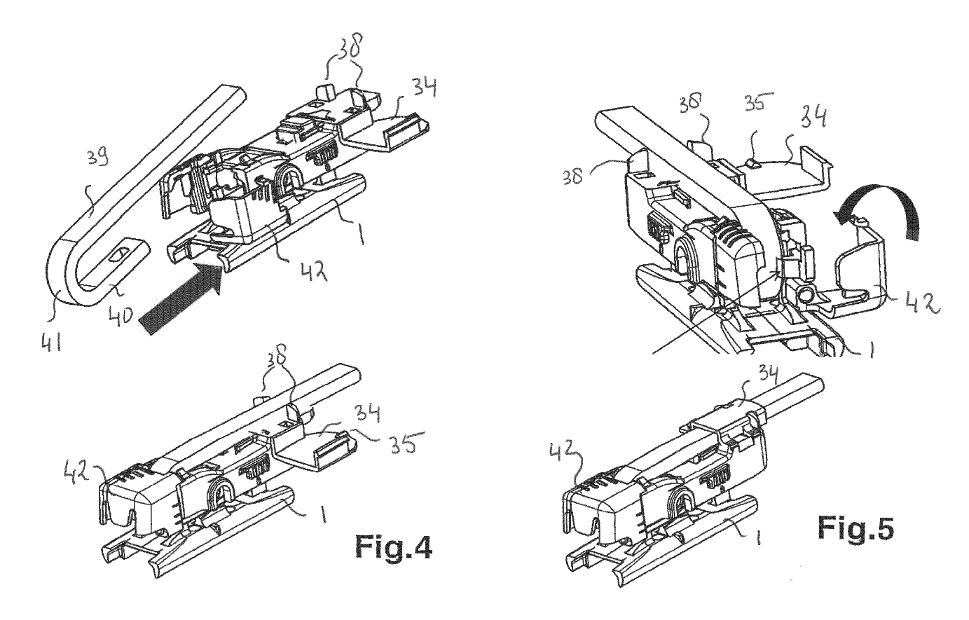

As depicted in FIG. 3 on the right, the cover 3 comprises a cap 34 on an upper surface thereof provided with an in use downwardly extending protrusion 35, wherein the downwardly extending protrusion 35 is adapted to engage in a correspondingly shaped hole 36 provided in the oscillating arm 22 of the fifth type for retaining the wiper blade onto the oscillating arm 22. The cap 34 has a U-shaped cross-section, wherein the protrusion 35 extends from a base of the U-shaped cross-section of the cap 34 in downward direction in use. The cap 34 near an edge of the upper surface is hingeably connected to the cover 3 between a closed position (seen in FIGS. 3 and 5), wherein the wiper blade can be retained onto the oscillating arm 22, and an open position (seen in FIGS. 4 and 5), wherein the wiper blade can be released from the oscillating arm 22. The recess 33 in a base of a U-shaped cross-section of the cover is arranged for receiving a free end 37 of the oscillating arm 7 (FIG. 3). As shown in FIG. 4, the cover 3 further comprises two spaced-apart guiding protrusions 38 extending upwardly from an upper surface of the cover 3, wherein the guiding protrusions 38 are adapted to receive the free end 37 of the oscillating arm 22 between them.

FIGS. 4 and 5 reveal several steps of mounting a unit consisting of the connecting device 1, the joint part 2 and the cover 3 to the oscillating arm 21 of the fourth type comprising two longitudinal arm sections 39,40 connected to each other by means of a curved intermediate section 41. As shown, a free end 42 of the joint part 2 is hingeable about a longitudinal axis of the windscreen wiper device between an open position, wherein the wiper blade can be released from the oscillating arm 21 of the fourth type, and a closed position, wherein the wiper blade can be retained on the oscillating arm 21. In the open position the longitudinal arm section 40 in use facing towards a windscreen to be wiped is introduced in the longitudinal channel 9 of the connecting device 1 and between a base and legs 14,15 of a U-shaped cross-section of the joint part 2.

The free end 42 is subsequently closed, wherein finally, also the cap 34 is closed, while the longitudinal arm section 39 in use facing away from a windscreen to be wiped is kept between the guiding protrusions 38.

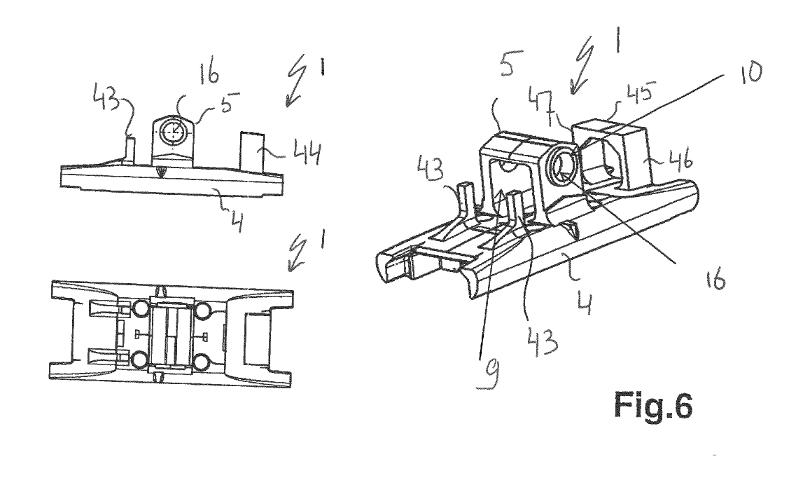

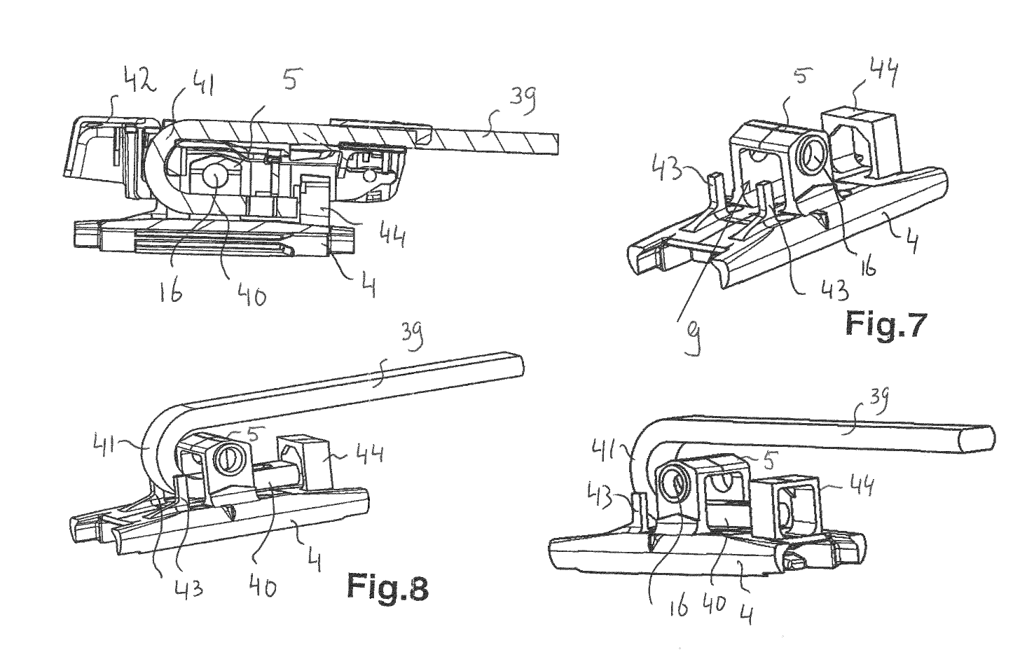

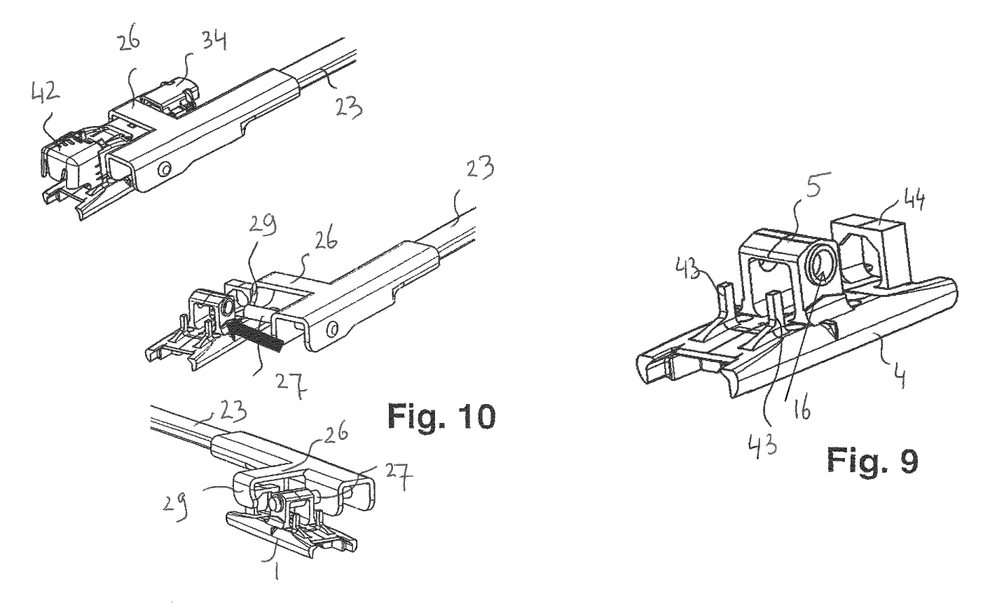

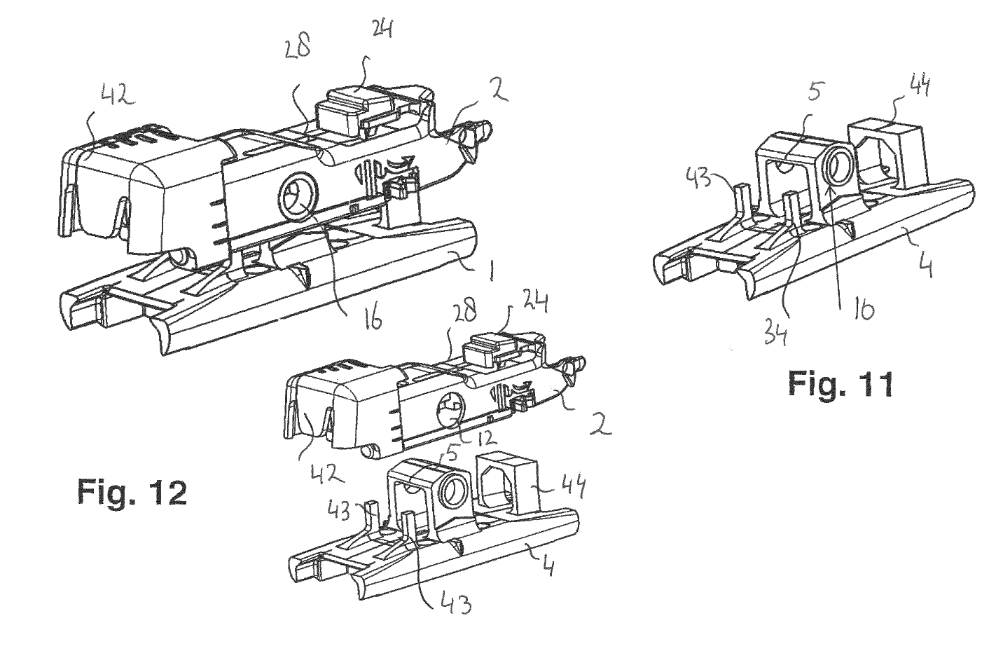

In FIGS. 6 through 12 corresponding parts have been designated with the same reference numerals. The connecting device 1 comprises two spaced-apart guiding protuberances 38 extending upwardly from an upper surface of flat base part 4 in order to guide the longitudinal arm section 40 of the oscillating arm 21 of the fourth type. In the embodiment of FIG. 6 the connecting device I further comprises a second top part 44 also in one piece therewith and having a U-shaped cross-section, wherein a base 45 and legs 46,47 of the U-shaped cross-section further define the channel 9 between them arranged to accommodate the longitudinal arm section 40 of the oscillating arm 21 of the fourth type.

The invention is not restricted to the variants shown in the drawing, but it also extends to other embodiments that fall within the scope of the appended claims.

1. A windscreen wiper device of the flat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm; a joint part is detachably connected to said connecting device by engaging protrusions of said connecting device, at the location of a pivot axis, in recesses provided in said joint part, wherein said protrusions of said connecting device are provided with co-axial through holes, wherein
an upper surface of said joint part comprises a recess arranged to accommodate a L-shaped shoulder provided near said free end of an oscillating arm of a first type, wherein said co-axial through holes are arranged to receive a transverse pivot pin provided near a free end of an oscillating arm of the first type, and wherein a side of said joint part is arranged to abut a leg of said L-shaped shoulder disposed at an end thereof and facing a windscreen to be wiped;
said joint part comprises at least one resilient tongue arranged to engage into a correspondingly shaped hole provided in a base of a U-shaped cross-section of an oscillating arm of a second type, wherein said resilient tongue is hingeable about a hinge axis between a inward position, wherein said wiper blade can be released from the oscillating arm of the second type, and an outward position, wherein said wiper blade can be retained on the oscillating arm of the second type;
said joint part is provided with a free end having a recess arranged to accommodate a free end of an oscillating arm of a third type, wherein said joint part comprises at least one protrusion extending laterally from a longitudinal side of said joint part, said protrusion being arranged to hook behind a correspondingly shaped protrusion on the oscillating arm of the third type for blocking a longitudinal movement of said wiper blade with respect to the oscillating arm of the third type.

2. The windscreen wiper device according to claim 1, wherein said joint part has an at least substantially U-shaped cross-section at the location of its connection to said connection device, wherein said joint part in each leg of said U-shaped cross-section is provided with said recess provided co-axially with said pivot axis, and wherein said co-axial recesses of said legs of said U-shaped cross-section and said co-axial through holes of said protrusions of said connecting device are arranged to receive the pivot pin of the oscillating arm of the first type.

3. The windscreen wiper device according to claim 1, wherein said joint part has an at least substantially U-shaped cross-section at the location of its connection to said connection device, and wherein a base of said U-shaped cross-section of said joint part comprises said resilient tongue extending outwardly.

4. The windscreen wiper device according to claim 1, wherein said hinge axis is located near an inner edge of said joint part.

5. The windscreen wiper device according to claim 1, wherein said hinge axis is located near an outer edge of said joint part.

6. The windscreen wiper device according to claim 1, wherein said joint part has an at least substantially U-shaped cross-section at the location of its connection to said connection device, and wherein a base of said U-shaped cross-section of said joint part comprises said recess arranged to accommodate the free end of the oscillating arm of the third type.

7. The windscreen wiper device according to claim 6, wherein said free end of said joint part is resilient and can pivot about a hinge axis between a first position for mounting or dismounting the free end of the oscillating arm of the third type into or from said recess in the base of the U-shaped cross-section of said joint part, and a second position for connecting the free end of the oscillating arm of the third type to said joint part.

8. The windscreen wiper device according claim 1, wherein said connecting device comprises a longitudinal channel arranged to receive an oscillating arm of a fourth type comprising two longitudinal arm sections connected to each other by scans of a curved intermediate section.

9. The windscreen wiper device according to claim 8, wherein said joint part has an at least substantially U-shaped cross-section at the location of its connection to said connection device, and wherein said longitudinal channel, a base and legs of the U-shaped cross-section of said joint part are arranged to receive a longitudinal arm section of the oscillating arm of the fourth type that in use is facing towards a windscreen to be wiped.

10. The windscreen wiper device according to claim 8, wherein said free end of said joint part is movable between an open position, wherein said wiper blade can be released from the oscillating arm of the fourth type, and a closed position, wherein said wiper blade can be retained on the oscillating arm of the fourth type.

11. The windscreen wiper device according to claim 10, wherein said free end of said joint part is hingeable between said open and closed positions about a longitudinal axis of the windscreen wiper device.

12. The windscreen wiper device according to claim 1, wherein a cover is detachably connected to said joint part.

13. The windscreen wiper device according to claim 12, wherein said cover is detachably connected to said joint part by engaging protrusions of said connecting device, at the location of said pivot axis, in recesses provided in said cover.

14. The windscreen wiper device according to claim 12, wherein an upper surface of said cover comprises a recess arranged to accommodate a rod-shaped oscillating arm of a fifth type; a L-shaped shoulder near the free end of the oscillating arm of the first type.

15. The windscreen wiper device according to claim 12, wherein said cover comprises a cap provided with a protrusion in use extending in downward direction towards a windscreen to be wiped, and wherein said downwardly extending protrusion is adapted to engage in a correspondingly shaped hole provided in the oscillating arm of the fifth type for retaining said wiper blade onto the oscillating arm of the fifth type.

16. The windscreen wiper device according to claim 15, wherein said cap is hingeably connected to said cover between a closed position, wherein said wiper blade is retained onto the oscillating arm of the fifth type, and an open position, wherein said wiper blade can be released from the oscillating arm of the fifth type.

17. The windscreen wiper device according to claim 14, wherein said cover has an at least substantially U-shaped cross-section at the location of its connection to said joint part, and wherein said recess is provided in a base of the U-shaped cross-section.

18. The windscreen wiper device according to claim 14, wherein said cover comprises two spaced-apart guiding protrusions extending upwardly from an upper surface of said cover, and wherein said guiding protrusions are adapted to receive the oscillating arm of the fifth type between them.

19. The windscreen wiper device according to claim 14, wherein said cover is detachably connected to said joint part through a snapping/clipping operation.

20. A method for manufacturing a windscreen wiper device of the flat blade type comprising an elastic, elongated carrier element, as well as an elongated wiper blade of a flexible material, which can be placed in abutment with a windscreen to be wiped, which wiper blade includes at least one longitudinal groove, in which groove a longitudinal strip of the carrier element is disposed, which windscreen wiper device comprises a connecting device for an oscillating arm, a joint part is detachably connected to said connecting device by engaging protrusions of said connecting device, at the location of a pivot axis, in recesses provided in said joint part, wherein said protrusions of said connecting device are provided with co-axial through holes , wherein
an upper surface of said joint part comprises a recess arranged to accommodate a L-shaped shoulder provided near a free end of the oscillating arm of a first type, wherein said co-axial through holes are arranged to receive a transverse pivot pin provided near the free end of the oscillating arm of the first type, and wherein a side of said joint part is arranged to abut a leg of said L-shaped shoulder disposed at an end thereof and facing a windscreen to he wiped; said joint part comprises at least one resilient tongue arranged to engage into a correspondingly shaped hole provided in a base of a U-shaped cross-section of an oscillating arm of a second type, wherein said resilient tongue is hingeable about a hinge axis between a inward position, wherein said wiper blade can he released from the oscillating arm of the second type, and an outward position, wherein said wiper blade can be retained on the oscillating arm of the second type; said joint part is provided with a free end having a recess arranged to accommodate a free end of an oscillating arm of a third type, wherein said joint part comprises at least one protrusion extending laterally from a longitudinal side of said joint part, said protrusion being arranged to hook behind a correspondingly shaped protrusion on the oscillating arm of the third type for blocking a longitudinal movement of said wiper blade with respect to the oscillating arm of the third type.
